(19) United States
(12) Patent Application Publication
(10) Pub. No.: US 2010/0245895 A1
(43) Pub. Date: Sep. 30, 2010

(54) CONTROL DEVICE, IMAGE FORMING APPARATUS, COMPUTER READABLE MEDIUM, AND CONTROL METHOD

(75) Inventor: Takumi KAWAHARA, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD, TOKYO (JP)

(21) Appl. No.: 12/564,936

(22) Filed: Sep. 23, 2009

(30) Foreign Application Priority Data
Mar. 24, 2009 (JP) 2009-072899

(51) Int. Cl. G06F 15/00

(52) U.S. Cl. 358/1.15

(57) ABSTRACT

A control device includes: a determination unit that determines a beginning original document to which a function that lays out a plurality of original documents onto a single sheet with predetermined number of original documents and forms an image is applied; a judgment unit that sequentially judges whether the original document is the object to be laid out onto a single sheet together with other original documents, starting with the beginning original document; an original document number determination unit that determines the number of original documents formed on a single sheet, that is within the predetermined number of original documents and does not make blank spaces, based on the number of original documents to which judgments by the judgment unit are done and judgment results of the judgment unit; and an image forming start unit that makes an image forming unit start to form the image based on the number of original documents determined by the original document number determination unit.

### CROSS-REFERENCE TO RELATED APPLICATION

This application is based on and claims priority under 35 USC 119 from Japanese Patent Application No. 2009-072899 filed Mar. 24, 2009.

### BACKGROUND

1. Technical Field

This invention relates to a control device, an image forming apparatus, a computer readable medium, and a control method.

2. Related Art

There has been conventionally known an image forming apparatus that has functions to print multiple pages on a single sheet, such as a printer, a copier and a complex machine featuring functions such as a print mode, a scan mode, a copy mode, and a facsimile mode. Hereinafter, printing multiple pages on a single sheet is called a page-layout printing.

### SUMMARY

According to an aspect of the present invention, there is provided a control device including: a determination unit that determines a beginning original document to which a function that lays out a plurality of original documents onto a single sheet with predetermined number of original documents and forms an image is applied; a judgment unit that sequentially judges whether the original document is the object to be laid out onto a single sheet together with other original documents, starting with the beginning original document; an original document number determination unit that determines the number of original documents formed on a single sheet, that is within the predetermined number of original documents and does not make blank spaces, based on the number of original documents to which judgments by the judgment unit are done and judgment results of the judgment unit; and an image forming start unit that makes an image forming unit start to form the image based on the number of original documents determined by the original document number determination unit.

### BRIEF DESCRIPTION OF THE DRAWINGS

Exemplary embodiments of the present invention will be described in detail based on the following figures, wherein:

FIG. 1 is a diagram showing an example of a system configuration of an image forming apparatus in accordance with an exemplary embodiment of the present invention;

FIG. 2 is a diagram showing an example of a hardware structure of a controller;

FIG. 3 is a functional block diagram showing functions of the controller;

FIGS. 4 through 12 are flowcharts showing a process the controller executes;

FIGS. 13A and 13B are diagrams showing a comparison of images outputted from the image forming apparatus; and

FIGS. 14A and 14B are timing charts comparing the timing of when the image forming is started.

### DETAILED DESCRIPTION

A description will now be given, with reference to the accompanying drawings, of exemplary embodiments of the present invention.

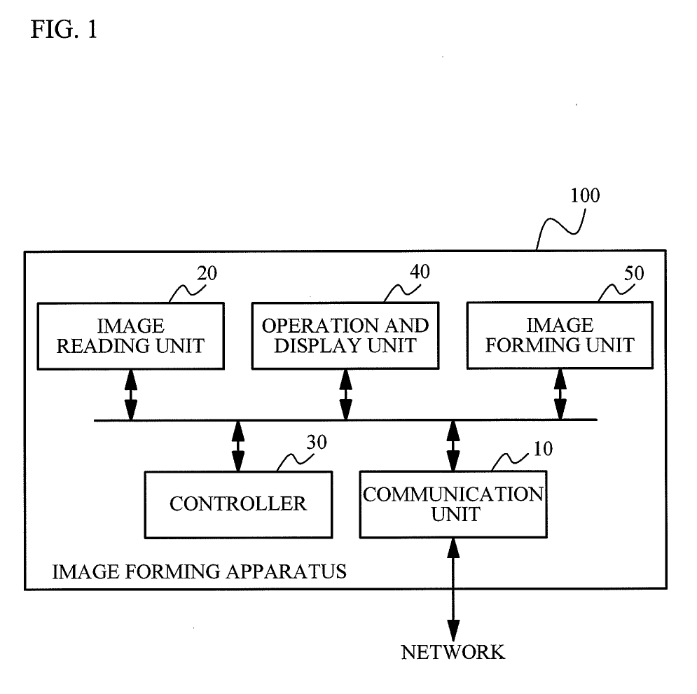

A system configuration of an image forming apparatus 100 in accordance with an exemplary embodiment of the present invention will now be described, with reference to FIG. 1.

The image forming apparatus 100 includes a communication unit 10, an image reading unit 20, a controller 30, an operation and display unit 40, and an image forming unit 50. The image forming apparatus 100 connects to a network as a communication part such as LAN (Local Area Network), and communicates with an information processing apparatus, an image data input apparatus, and another image forming apparatus via the network. A printer, a copier, a fax, and a complex machine may be the image forming apparatus 100.

The communication unit 10 receives image data outputted from the information processing apparatus and the image data input apparatus via the network. The communication unit 10 outputs the received image data to the controller 30.

The image reading unit 20 reads the image based on a reading request of original documents from the controller 30. The image reading unit 20 outputs the image data of the original document that the image reading unit 20 has read to the controller 30. The image reading unit 20 is an image reading apparatus featuring the scanning function such as a scanner in concrete terms.

The controller 30 receives the image data received by the communication unit 10 via the network from the communication unit 10. The controller 30 receives the image data of the original document read by the image reading unit 20 from the image reading unit 20.

The controller 30 controls the image reading unit 20 and the image forming unit 50 based on instructions inputted from the operation and display unit 40. The controller 30 controls the operation and display unit 40 to display the information about an error when the error occurs for example.

The controller 30 forms the image onto a sheet of paper (recording medium) put in the image forming apparatus 100 by controlling the image forming unit 50 based on the instruction received from the operation and display unit 40 and the image data received from the communication unit 10 or the image reading unit 20. When the page-layout printing is requested, the controller 30 lays out the image data to fit onto a single sheet without unnecessary blank spaces, and forms the image by controlling the image forming unit 50, as will hereinafter be described in detail.

The operation and display unit 40 is a so-called user interface. The user inputs instructions to the operation and display unit 40 for reading original documents and outputting images. The user can input the number of pages of the original documents that the user wants to print on a single sheet (the number of pages per sheet) to the operation and display unit 40 when the user executes the page-layout printing. The operation and display unit 40 receives the instructions inputted by the user, and outputs the instructions to the controller 30. The operation and display unit 40 displays the error information and notes for the user.

The image forming unit 50 forms the image based on the image data received from the controller 30 onto a paper according to the instructions from the controller 30.

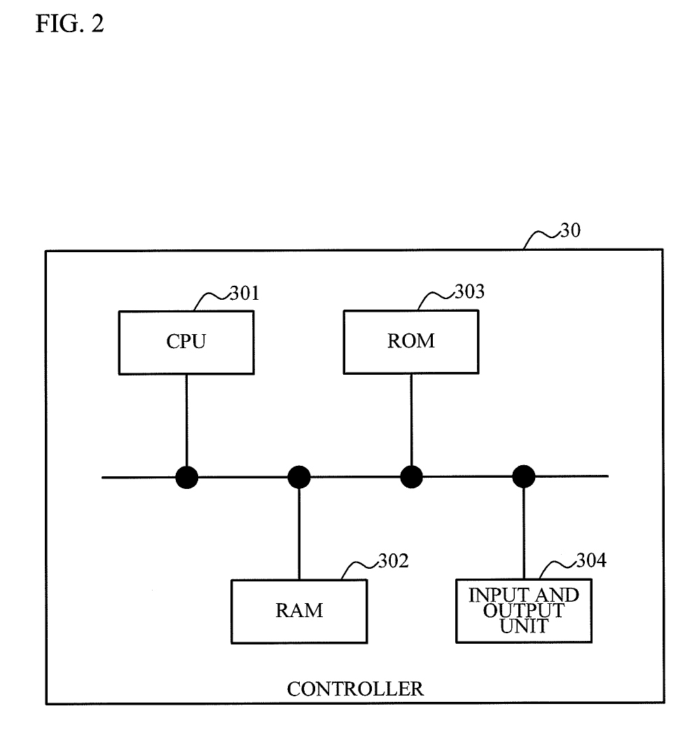

A hardware structure of the controller 30 of the image forming apparatus 100 will be described, with reference to FIG. 2.

FIG. 2 is a diagram showing an example of the hardware structure of the controller 30 of the image forming apparatus 100. The controller 30 includes: an input and output unit 304 that inputs and outputs signal; a ROM (Read Only Memory) 303 that stores the program to determine the number of original documents to be laid out and configuration information used in the program; a CPU (Central Processing Unit) 301 that reads the program stored in the ROM (Read Only Memory) 303 and executes the program; and a RAM (Random Access Memory) 302 that stores temporary data used when the program is executed.

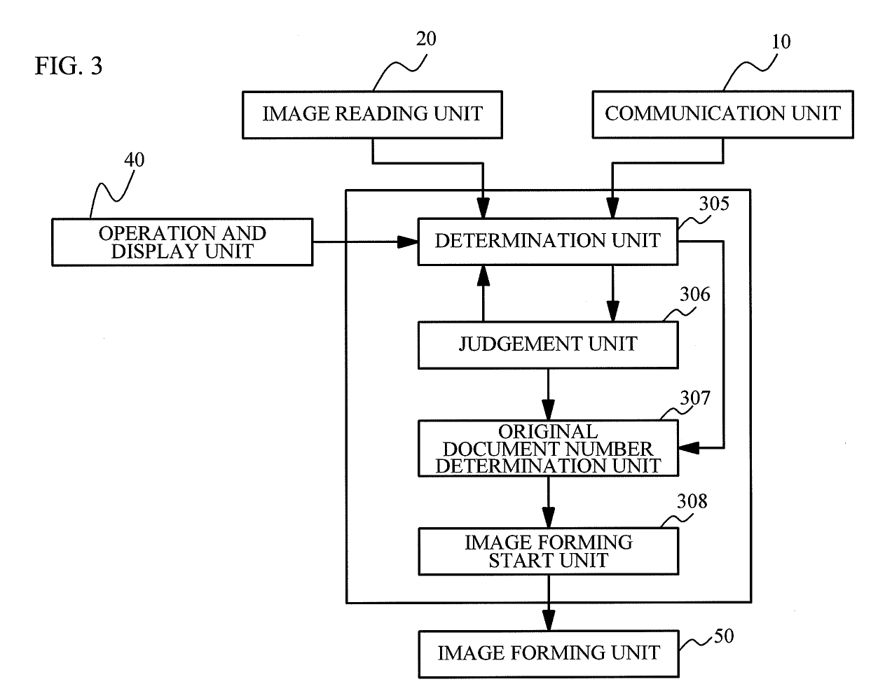

Functions that a determination unit 305, a judgment unit 306, a original document number determination unit 307 and the image forming start unit 308 illustrated in FIG. 3 have are implemented with the operation of the program stored in the ROM 303 by the CPU 301.

The configuration information and the default value information used in the program can be stored in other memories such as NVM (Non Volatile Memory).

Functions implemented with the cooperation between the hardware such as the CPU 301 and the program stored in the ROM 303 in the controller 30 of the image forming apparatus 100 will be described, with reference to FIG. 3.

The controller 30 contains a determination unit 305, a judgment unit 306, an original document number determination unit 307, and an image forming start unit 308.

The determination unit 305 connects to the communication unit 10, the image reading unit 20, the operation and display unit 40, the judgment unit 306, and the original document number determination unit 307.

The determination unit 305 receives sequentially the image data (original documents) for image forming from the image reading unit 20, or the communication unit 10.

Additionally, the determination unit 305 receives a judgment result of whether the original document is the object for the page-layout printing from the judgment unit 306. Hereinafter, the object for the page-layout printing is called the page-layout object.

When the operation and display unit 40 receives the request of the page-layout printing from the user, the determination unit 305 determines the beginning original document for the page-layout printing among the original documents received from the image reading unit 20 or the communication unit 10 based on the judgment result from the judgment unit 306. When the determination unit 305 receives the judgment result that the original document is not the page-layout object from the judgment unit 306, the determination unit 305 determines that the original document next to the original document that is not the page-layout object is the beginning original document for the page-layout printing. Then, the determination unit 305 outputs the original documents that the determination unit 305 has received to the judgment unit 306, and outputs the information about the beginning original document for the page-layout printing to the original document number determination unit 307.

Now the determination of the beginning original document for the page-layout printing will be described more specifically. When the operation and display unit 40 receives the request of the page-layout printing of which the number of pages per sheet is four, the determination unit 305 determines the first original document is the beginning original document for the page-layout printing. Then, when the determination unit 305 receives the judgment result that all original documents are the page-layout objects, the determination unit 305 determines the fifth original document is the next beginning original document for the page-layout printing. Meanwhile, when the determination unit 305 receives the judgment result that the third original document is not the page-layout object before the determination unit 305 receives four, which is the number of pages per sheet, original documents, the determination unit 305 determines the fourth original document is the next beginning original document for the page-layout printing.

The judgment unit 306 connects to the determination unit 305 and the original document number determination unit 307.

The judgment unit 306 judges whether the original document from the determination unit 305 is the page-layout object, which is laid out onto a single sheet together with other original documents.

The judgment unit 306 can judge whether the original document is the page-layout object by judging whether the original document data contains an indication that indicates the original document is the page-layout object, or by judging whether the characters contained in the original document are legible when the page-layout printing is executed. When the page-layout printing is executed, the original document is printed in reduced size. However, if the characters contained in the original document are not legible because of the reduced printing, it is not convenient for the user. Therefore, the judgment unit 306 can judge that the original document is the page-layout object if the characters contained in the original document are legible when the page-layout printing is executed. The judgment unit 306 can judge that the original document is not the page-layout object if the characters contained in the original document are not legible. The judgment unit 306 can judge whether the characters contained in the original document are legible, or another program can judge it and outputs the judgment result to the judgment unit 306.

Whether the characters in the original document are legible can be judged by comparing the black pixel ratio in the reduced original document with the black pixel ratio in the original document or by determining whether the character size of characters in the reduced original document is more than the predetermined size.

The judgment unit 306 outputs the original documents and the judgment result of whether each original document is the page-layout object to the original document number determination unit 307.

The judgment unit 306 outputs the judgment result to the determination unit 305 when the original document that is not the page-layout object exists.

The original document number determination unit 307 connects to the determination unit 305, the judgment unit 306, and the image forming start unit 308. The original document number determination unit 307 acquires the information about the beginning original document for the page-layout printing from the determination unit 305. The original document number determination unit 307 acquires the original documents and the judgment result of whether each original document is the page-layout object from the judgment unit 306.

The original document number determination unit 307 acquires the original documents from the judgment unit 306, and counts the number of pages of the original documents acquired from the judgment unit 306. When the original document that is not the page-layout object does not exist till the number of pages of the original documents that is counted from the beginning original document becomes the number of pages per sheet, the original document number determination unit 307 determines that the number of original documents laid out onto a single sheet is the number of pages per sheet. Then, the original document number determination unit 307 creates the image data that contains the same number of original documents laid out onto a single sheet as the number of pages per sheet, and outputs the image data to the image forming start unit 308. The case that the original document that is not the page-layout object does not exist till the number, which is counted from the beginning original document for the page-layout printing, of original documents acquired becomes the number of pages per sheet indicates that all the original documents from the beginning original document for the page-layout printing to the original document with the counted number that is the number of pages per sheet are the page-layout objects.

More concretely, when the number of pages per sheet is two, the original document number determination unit 307 acquires two sheets of original documents from the judgment unit 306. When all of these two sheets of original documents are the page-layout objects, the original document number determination unit 307 creates image data that two sheets of original documents are laid out onto a single sheet, and outputs the image data to the image forming start unit 308. When the number of pages per sheet is four, the original document number determination unit 307 acquires four sheets of original documents. When all of these four sheets of original documents are the page-layout objects, the original document number determination unit 307 creates image data that the four sheets of original documents are laid out onto a single sheet, and outputs the image data to the image forming start unit 308.

Meanwhile, assume that the original document that is not the page-layout object exists before the number, which is counted from the beginning original document for the page-layout printing of pages, of original documents acquired from the judgment unit 306 becomes the number of pages per sheet. In this case, the original document number determination unit 307 determines the number of original documents laid out onto a single sheet for the original documents from the beginning original document for the page-layout printing to the original document which is not the page-layout object so that unnecessary blank spaces are not formed and the number is within the number of pages per sheet. If the original document number determination unit 307 determines that the number of original documents laid out onto a single sheet is the maximum number which does not create unnecessary blank space and is within the number of pages per sheet, it may reduce paper usage. The original document number determination unit 307 creates image data in which the original documents are laid out based on the number of original documents determined, and outputs the image data to the image forming start unit 308.

More concretely, assume that; the number of pages per sheet is four, the original document number determination unit 307 acquires three sheets of original documents, and first two sheets of original documents are the page-layout objects but third one is not the page-layout object. In this case, the original document number determination unit 307 determines that the number of original documents laid out onto a single sheet for first two sheets of original documents is two, and lays out the first two sheets of original documents onto a single sheet. The original document number determination unit 307 determines that the number of original documents laid out onto a single sheet for the third one is one (same size printing), and lays out third one onto a single sheet. The reason why the original document number determination unit 307 determines that the number of original documents laid out onto a single sheet for first two sheets of original documents is two, and lays out the first two sheets of original documents onto a single sheet is that if the original document number determination unit 307 determines that the number of original documents laid out onto a single sheet is four, two of four areas, which are made by cutting a sheet into four areas, become unnecessary blank spaces.

The image forming start unit 308 connects to the original document number determination unit 307 and the image forming unit 50. When the image forming start unit 308 receives the image data including the laid out original documents from the original document number determination unit 307, the image forming start unit 308 makes the image forming unit 50 start image forming based on the image data.

Although the original document number determination unit 307 creates the image data including the laid out original documents in this embodiment, it may be possible that the original document number determination unit 307 determines the number of original documents laid out onto a single sheet, and that the image forming start unit 308 creates the image data including the laid out original documents based on the number of original documents determined.

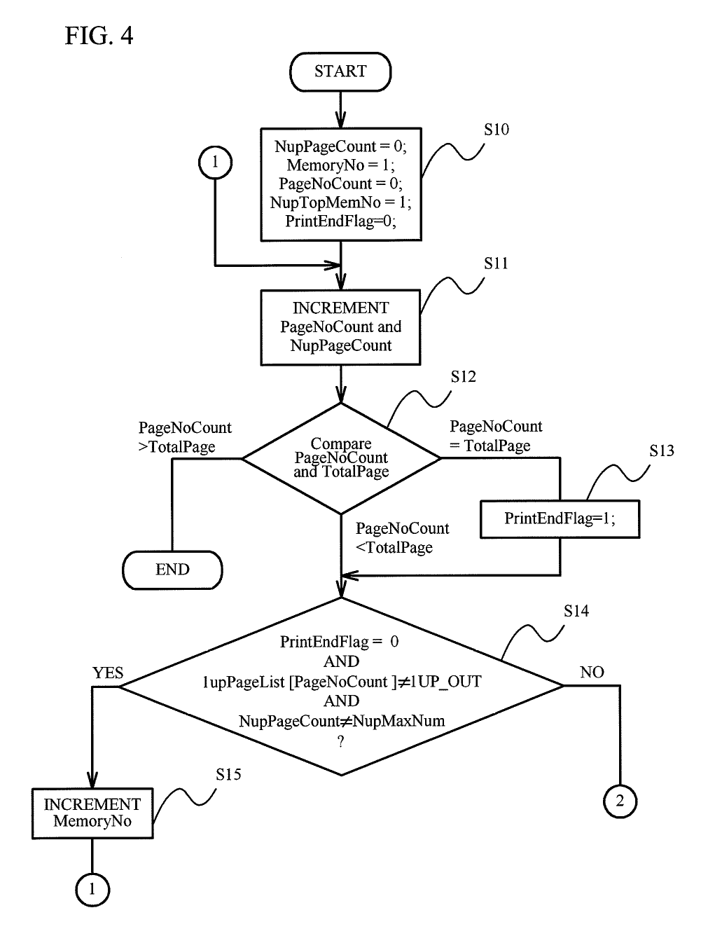

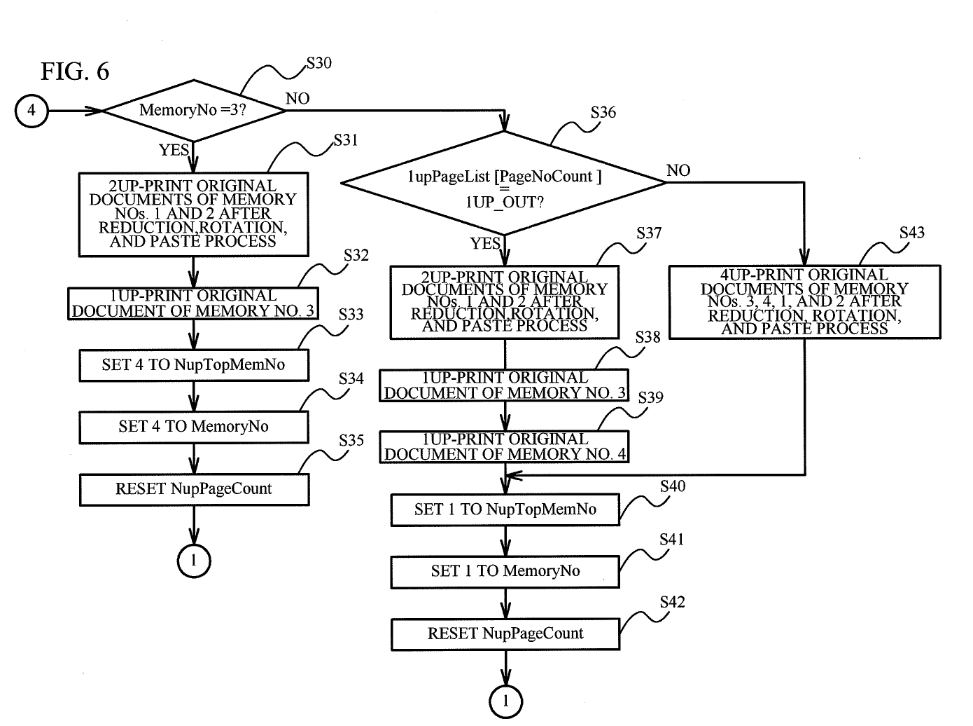

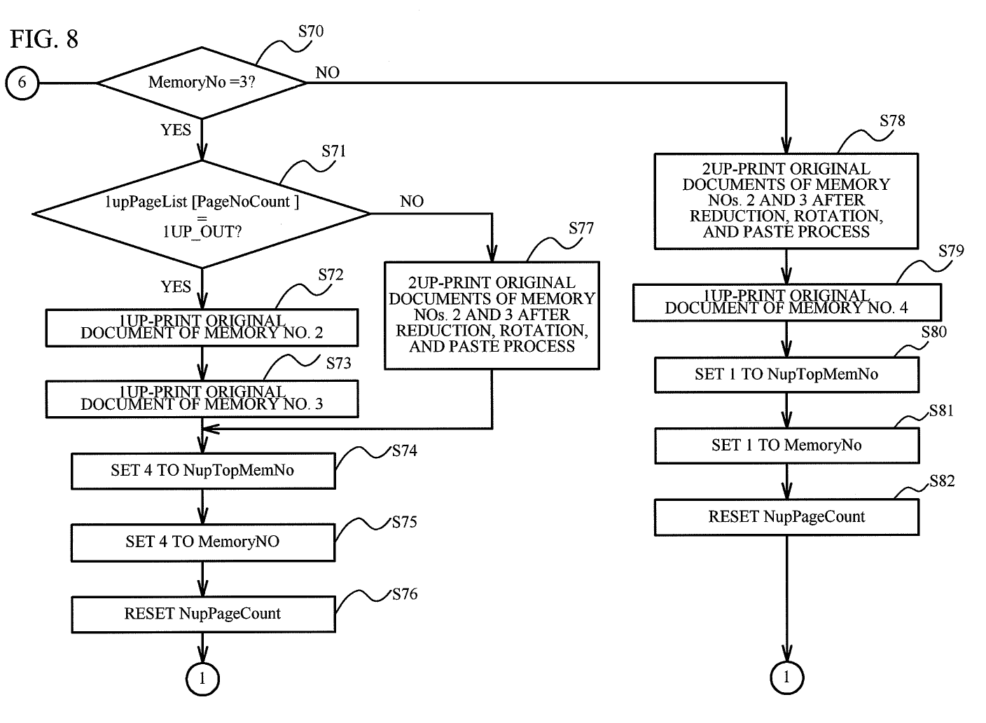

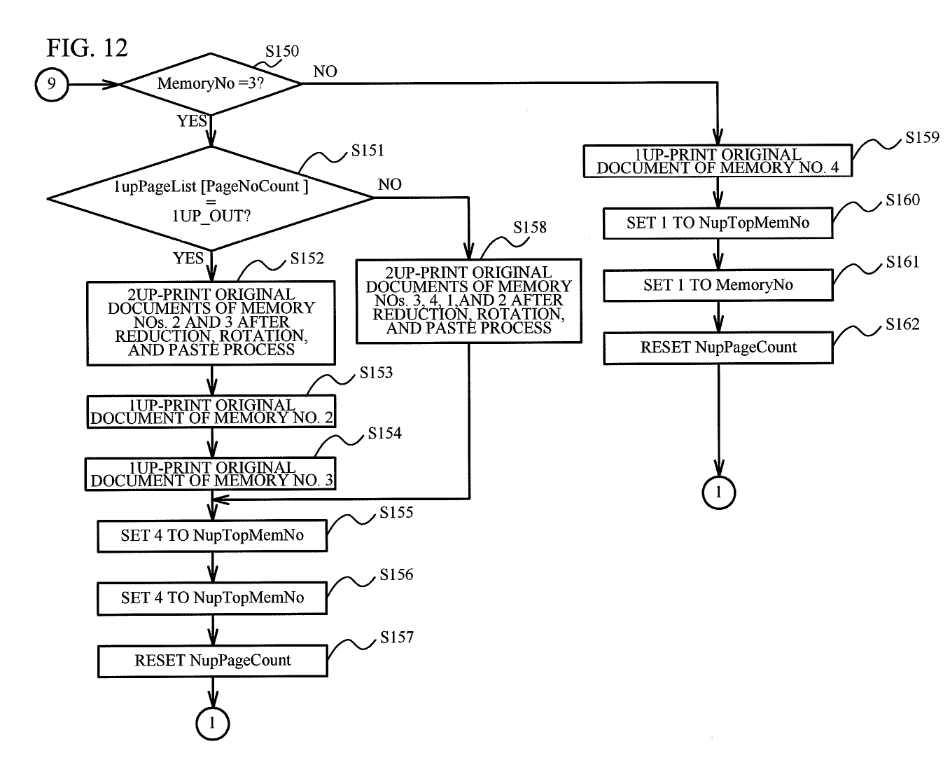

Now an example of the process that the controller 30 executes will be described, with reference to FIGS. 4 through 12. FIGS. 4 thorough 12 are flowcharts showing an example of the process that the controller 30 executes when the number of pages per sheet is four.

Here, each procedure in the flowchart is described with a concrete example. All procedures are not described when the flowchart is described with a concrete example. However, the procedures that are not described with the concrete example have operations in common with the procedures that will be described, and it is understandable with the procedures that will be described. Accordingly, some of the procedures are skipped in this description.

In this embodiment, as a concrete example, the flowchart will be described under the case that the number of pages per sheet is four, the number of sheets of the original documents is ten, and second sheet and ninth sheet are not the page-layout objects (this means first, third to eighth, and tenth sheets are the page-layout objects). Nth sheet of the original document will be called the original document N, hereinafter.

The controller 30 initializes parameters for this process (step S10). In the step S10 of FIG. 4, NupPageCount is a counting parameter for a single sheet for the page-layout printing, and takes the value from one to the number of pages per sheet (four in this case). MemoryNo is a parameter that indicates the memory No. in which the original documents that the determination unit 305 acquires are stored, and takes the value from one to the number of pages per sheet (four in this case). PageNoCount is a counting parameter for counting the number of original documents, and takes the value from one to the total number of original documents (ten in this case). NupTopMemNo is a parameter that indicates the memory No. in which the beginning original document for the page-layout printing is stored, and takes the value from one to the number of pages per sheet (four in this case). PrintEndFlag is a flag to end the printing.

The controller 30 increments PageNoCount and NupPageCount after the initialization (step S11). Then the controller 30 compares PageNoCount and TotalPage (step S12). TotalPage is the total number of original documents, and is ten in this case. When the original documents are read by the image reading unit 20 with the automatic document feeder, the number of original documents are unknown. In that case, the maximum number such as 999 is set to TotalPage.

When PageNoCount is greater than TotalPage, the controller 30 ends the process. When PageNoCount is equal to TotalPage, the controller 30 sets 1 to PrintEndFlag (step S13). When PageNoCount is less than TotalPage, the controller 30 goes to step S14.

In the concrete example, the controller 30 goes to step S14, because PageNoCount is 1 and TotalPage is 10.

The controller 30 determines whether PrintEndFlag is 0 and 1upPageList[PageNoCount] is not 1UP_OUT and NupPageCount is not NupMaxNum (step S14). 1upPageList[PageNoCount] indicates whether the original document of PageNoCount is the page-layout object. 1UP_OUT means that the original document is not the page-layout object (it means that the number of original documents laid out onto a single sheet is one). NupMaxNum is the maximum number of the original documents laid out onto a single sheet, and corresponds with the number of pages per sheet. In the concrete example, NupMaxNum is four.

When the determination of the step S14 is YES, the controller 30 increments MemoryNo (step S15). Then, the controller 30 repeats the procedures from the step S11 to the step S15 until the determination of the step S14 is No or this process ends.

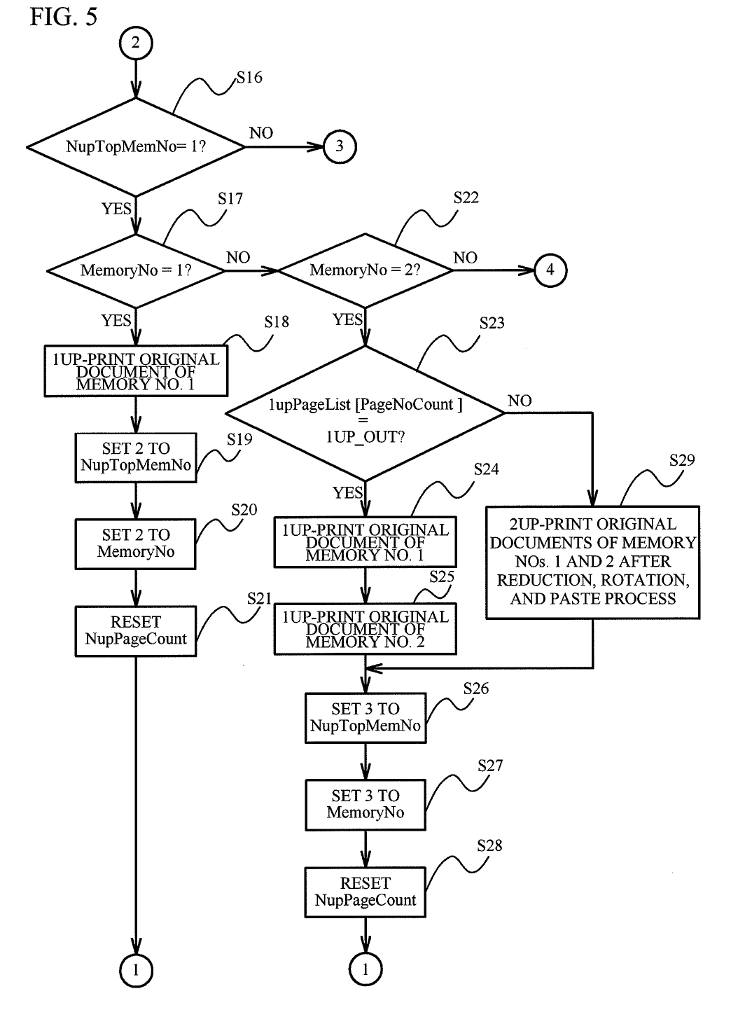

The controller 30 goes to the step S16 of FIG. 5 when the determination of the step S14 is NO.

Now the description will be given with the concrete example. In the concrete example, the original documents 2 and 9 are not the page-layout objects. Therefore, because the determination of the step S14 to the original document 1 is YES, the controller 30 goes to the step S15, and increments MemoryNo to 2. Then the controller 30 goes to the step S11, and increments PageNoCount and NupPageCount to 2. Then the controller 30 executes the determination of the step S14. Because the original document 2 is not the page-layout object, 1upPageList[2] is 1UP_OUT. Therefore, because the determination of the step S14 is NO, the controller 30 goes to the step S16 of FIG. 5.

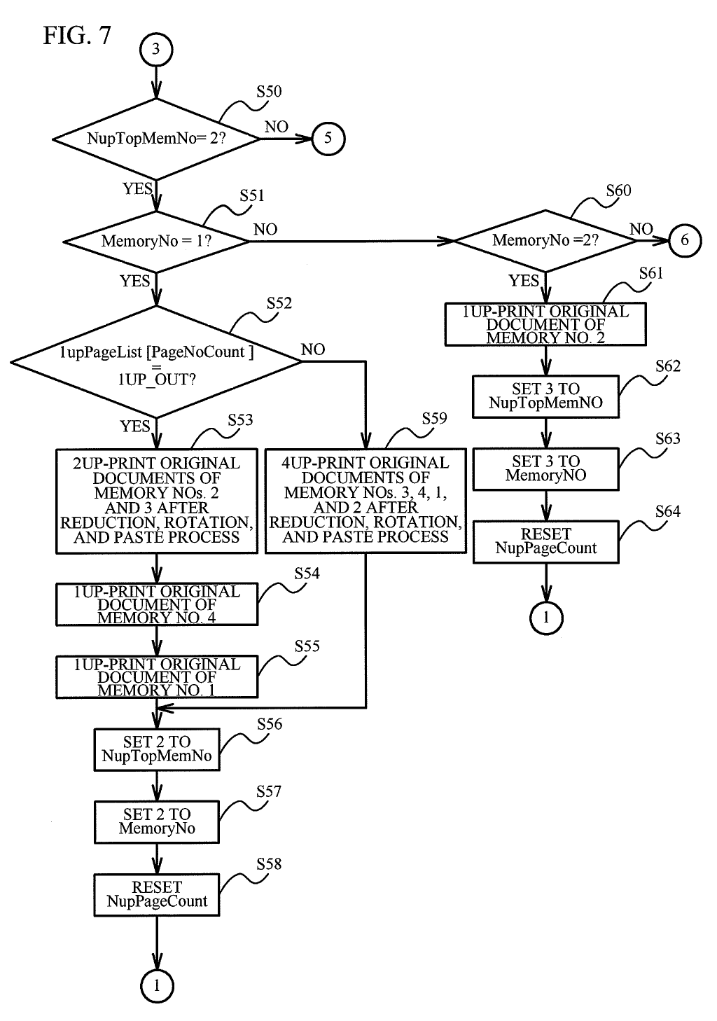

The controller 30 determines whether the NupTopMemNo is 1 (step S16). When NupTopMemNo is not 1 (step S16/NO), the controller 30 goes to the step S50 of FIG. 7. When NupTopMemNo is 1 (step S16/YES), the controller 30 determines whether MemoryNo is 1 (step S17).

When MemoryNo is 1 (step S17/YES), the controller 30 prints the original document stored in memory No. 1 under the condition that the number of original documents laid out onto a single sheet is one (hereinafter, call it 1up) (step S18). Hereinafter, printing the original documents under the condition the number of original documents laid out onto a single sheet is one is called 1up-print. Then, the controller 30 sets 2 to NupTopMemNo (step S19), sets 2 to MemoryNo (step S20), and resets NupPageCount (step S21).

Setting 2 to NupTopMemNo means determining the original document 2 as the beginning original document for the page-layout printing.

When MemoryNo is not 1 (step S17/NO), the controller 30 determines whether MemoryNo is 2 (step S22). When MemoryNo is not 2 (step S22/NO), the controller 30 goes to the step S30. When MemoryNo is 2 (step S22/YES), the controller 30 determines whether 1upPageList [PageNoCount] is 1UP_OUT (step S23).

When the determination of the step S23 is YES, the controller 30 1up-prints the original document stored in the memory No. 1 (the original document 1) (step S24). Then the controller 30 1up-prints the original document stored in the memory No. 2 (the original document 2). The reason why the controller 30 1up-prints the original document stored in the memory No. 1 in the step S24 is that three of four areas divided the one sheet into become unnecessary blank spaces if the number of original documents laid out onto a single sheet is four which is the number of pages per sheet, and the one area of two areas divided the one sheet into becomes an unnecessary blank space if the number of original documents laid out onto a single sheet is two.

Then the controller 30 sets 3 to NupTopMemNo (step S26), sets 3 to MemoryNo (step S27), and resets NupPageCount (step S28). Setting 3 to NupTopMemNo means determining the original document 3 as the beginning original document for the page-layout printing.

When the determination of the step S23 is NO, the controller 30 prints the original documents stored in the memory Nos. 1 and 2 after the reduction, the rotation, and the paste process under the condition that the number of original documents laid out onto a single sheet is two (2up) (step S29). The procedure in this step S29 means that when both of the read two original documents are the page-layout objects and the number of pages per sheet is two, the controller prints the images as the number of original documents laid out onto a single sheet is two which is the number of pages per sheet.

In the concrete example, because NupTopMemNo is 1, the controller 30 goes to the step S17. Then the controller 30 goes to the step S23 because MemoryNo is 2. The controller 30 goes to the step S24 because 1upPageList[2] is 1UP_OUT. The controller 30 1up-prints each of the original document 1 and the original document 2.

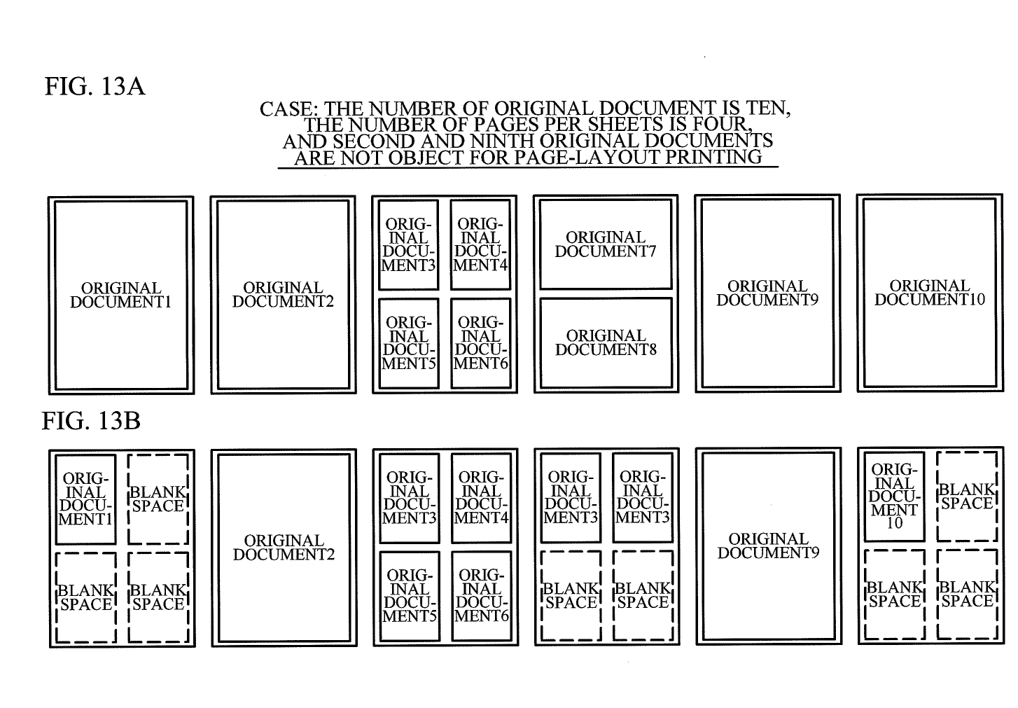

In FIG. 13A, the original documents 1 and 2 laid out on the sheets with the process mentioned above are illustrated. FIG. 13A is a diagram illustrating image examples outputted from the image forming unit 50 based on the control by the controller 30. As illustrated in FIG. 13A, the original documents 1 and 2 are 1up-printed.

The controller 30 goes back to the step S11 of FIG. 4 after the procedure of the step S21 or the step S28. It means that the controller 30 executes the procedures described above from the next beginning original document for the page-layout printing.

In the concrete example, because the original documents 3 to 5 are the page-layout objects, the controller 30 repeats the procedures of the step S11, S12, S14 and S15 three times. When the procedure of the step S15 for the original document 5 ends, NupPageCount is 3. Then the controller 30 executes the procedures of the steps S11 to S12 for the original document 6. After the procedures for the original document 6 are executed, the controller 30 determines that the determination of the step S14 is NO because NupPageCount becomes NupMaxNum (four in the concrete example) by the increment in the step S11, and goes to the step S16 of FIG. 5. At this time, MemoryNo is 2, NupTopMemNo is 3, and NupPageCount is 4.

When NupTopMemNo is not 1 (step S16/NO), the controller 30 goes to the step S50 of FIG. 7, and determines whether NupTopMemNo is 2 (step S50).

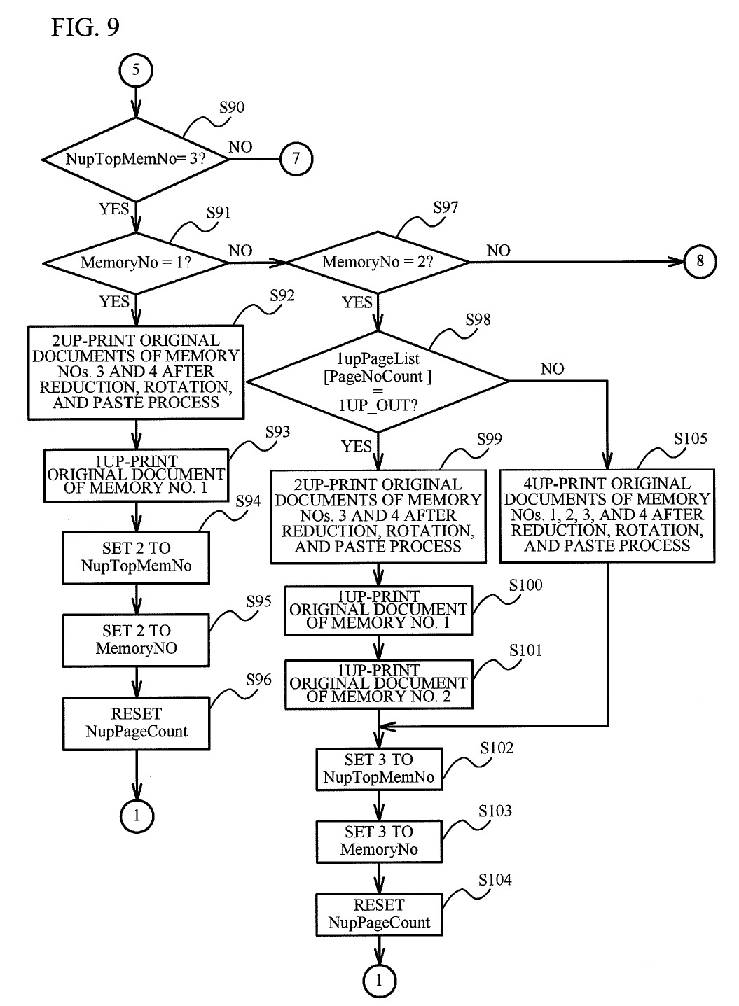

When NupTopMemNo is not 2 (step S50/NO), the controller 30 goes to the step S90 of FIG. 9, and determines whether NupTopMemNo is 3 (step S90).

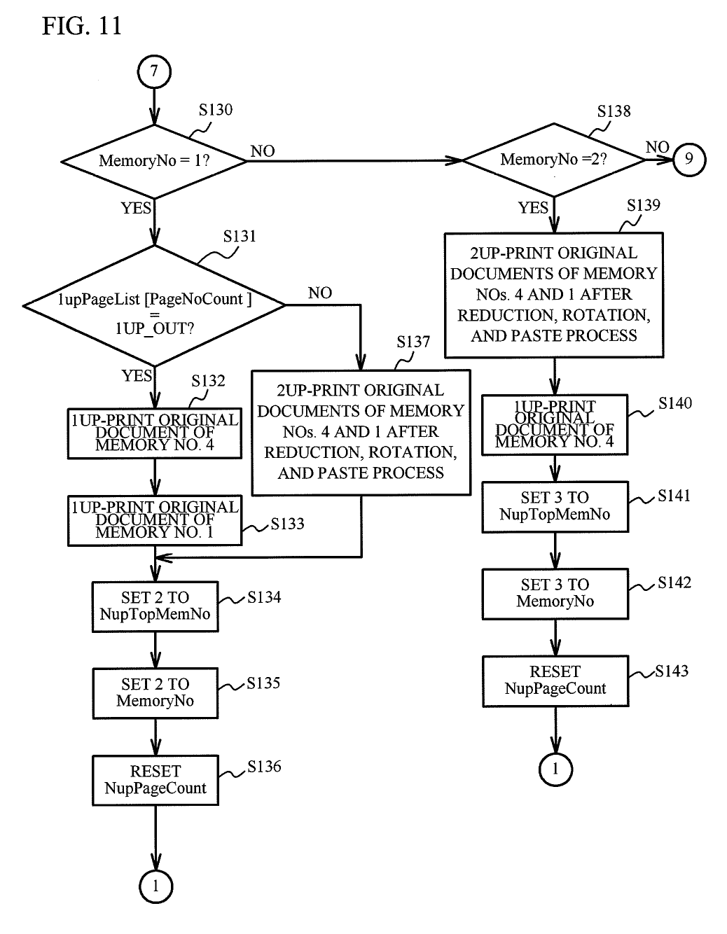

When NupTopMemNo is not 3 (step S90/NO), the controller 30 goes to the step S130 of FIG. 11. When NupTopMemNo is 3 (step S90/YES), the controller 30 determines whether MemoryNo is 1 (step S91).

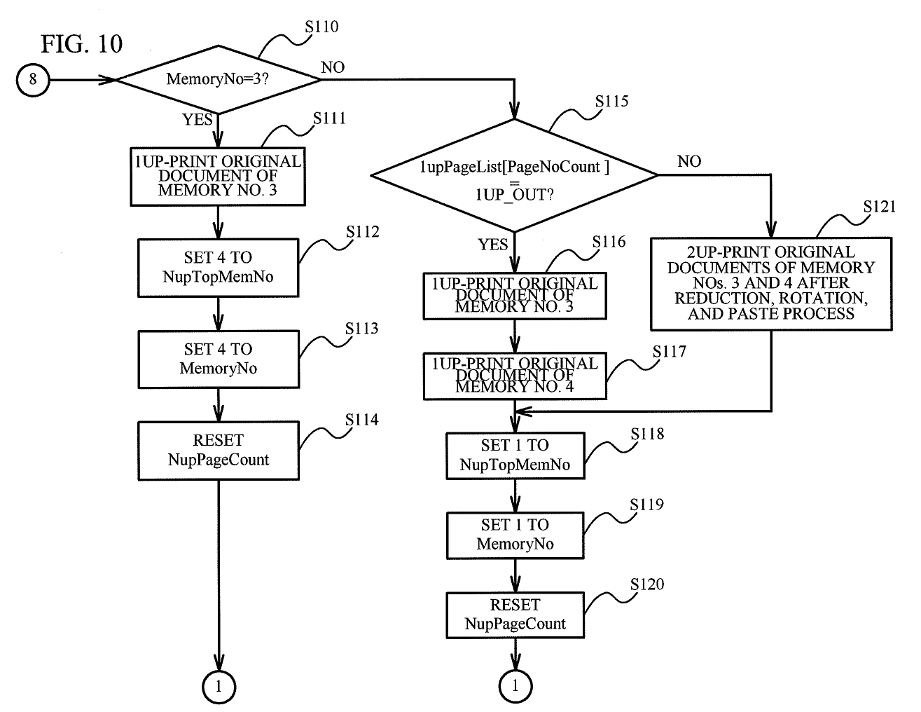

The controller 30 determines the value of MemoryNo between 1 to 4 by executing the procedures of the step S91 of FIG. 9, the step S97, and the step S110 of FIG. 10.

In the concrete example, because NupTopMemNo is 3 and

MemoryNo is 2, the controller 30 determines that the determination of the step S07 is YES, and goes to the step S98. Therefore, the procedures from the step S98 are described, hereinafter.

The controller 30 determines whether 1upPageList[PageNoCount] is 1UP_OUT (step S98).

When the determination of the step S98 is YES, the controller 30 creates the image data of the original documents stored in the memory Nos. 3 and 4 (the original document 3 and the original document 4) with the reduction, the rotation, and the paste process. The controller 30 prints the image data as the number of original documents laid out onto a single sheet is two (2up-print) (step S99). Then the controller 30 1up-prints the original document stored in the memory No. 1 (the original document 5) (step S100). Then the controller 30 1up-prints the original document stored in the memory No. 2 (the original document 6) (step S101).

The controller 30 sets 3 to NupTopMemNo (step S102), sets 3 to MemoryNo (step S103), and resets NupPageCount (step S104).

When the determination of the step S98 is NO, the controller 30 creates the image data of the original documents stored in the memory Nos. 3, 4, 1 and 2 (the original documents 3 to 6) with the reduction, the rotation, and the paste process. The controller 30 prints the image data as the number of original documents laid out onto a single sheet is four (4up-print) (step S105). The controller 30 goes back to step S11 of FIG. 4 after the procedure of the step S104.

In the concrete example, because the original document 6 is the page-layout object, 1upPageList[6] is not 1UP_OUT. Therefore, the controller 30 determines that the determination of the step S98 is NO, and prints the original documents 3 to 6 on a single sheet as the number of original documents laid out onto a single sheet is four. The original documents 3 to 6 are printed onto a single sheet as the number of original documents laid out onto a single sheet is four as illustrated in FIG. 13A. Then the controller 30 goes back to the step S11 of FIG. 4 after the procedure of the step S104, and executes the procedures described above from the next beginning original document for the page-layout printing (the original document 7).

Because the original document 7 and the original document 8 are the page-layout objects, the controller 30 repeats the procedures of the step S11, S12, S14, and S15 twice. Then the controller 30 executes the procedures of the steps S11 to S12. Because the original document 9 is not the page-layout object, 1upPageList[9] is 1UP_OUT. Therefore, the controller 30 determines that the determination of the step S14 is NO, and goes to the step S16. At this time, MemoryNo is 1, NupTopMemNo is 3, and NupPageCount is 3.

Because NupTopMemNo is 3 and MemoryNo is 1, the controller 30 goes to the step S92. The controller 30 creates the image data of the original documents stored in memory Nos. 3 and 4 (the original document 7 and the original document 8) with the reduction, the rotation, and the paste process, and 2up-prints the image data (step S92).

Then the controller 30 1up-prints the original document stored in memory No. 1 (the original document 9) (step S93). Then the controller 30 sets 2 to NupTopMemNo (step S94), sets 2 to MemoryNo (step S95), and resets NupPageCount (step S96).

As illustrated in FIG. 13A, the original documents 7 and 8 are printed as the number of the original documents laid out onto a single sheet is two, and the original document 9 is printed as the number of the original documents laid out onto a single sheet is one.

The controller 30 goes back to the step S11 of FIG. 4 after the procedure of the step S96. The controller 30 increments the PageNoCount and NupPageCount in the step S11. When the original document 10 is read in, PageNoCount becomes 10, which corresponds to the value of TotalPage. Therefore, the controller 30 goes to the step S13, and sets 1 to PrintEndFlag.

Because PrintEndFlag is 1, the controller 30 determines that the determination of the step S14 is NO, and goes to the process of the step S16. At this time, MemoryNo is 2, NupTopMemNo is 2, and NupPageCount is 1.

The controller 30 goes to the step S61 because NupTopMemNo is 2 and MemoryNo is 2. The controller 30 1up-prints the original document stored in the memory No. 2 (the original document 10) (step S61). Then the controller 30 sets 3 to NupTopMemNo (step S62), sets 3 to MemoryNo (step S63), and resets NupPageCount (step S64).

As illustrated in FIG. 13A, the original document 10 is printed as the number of the original documents laid out onto a single sheet is one.

The controller 30 goes back to the step S11 of FIG. 4 after the procedure of the step S64. The controller 30 increments PageNoCount and NupPageCount in the step S11. Because PageNoCount is 11, the controller 30 determines that the PageNoCount is greater than TotalPage in the step S12. Then the controller 30 terminates this process.

The number of the branching process to determine the value of NupTopMemNo and the value of MemoryNo changes according to the number of pages per sheet. It indicates that the number of branching processes gets greater if the number of pages per sheet is greater because the possible values of NupTopMemNo and MemoryNo will increase.

As described above, according to this embodiment, when the original document that is not the page-layout object does not exist till the number of original documents read in becomes the number of pages per sheet, the controller 30 creates the image data of which the number of original documents laid out onto a single sheet is the number of pages per sheet, and prints the image data, after reading the original documents of which the number is the number of pages per sheet. Additionally, when the original document that is not the page-layout object does exist before the number of original document read in becomes the number of pages per sheet, the controller 30 reduces the unnecessary blank space on the sheet by creating the image data of the original documents from the beginning original document for the page-layout-printing to the original document before the original document that is not the page-layout object as the number of original documents laid out onto a single sheet is the number that is within the number of pages per sheet and that does not make unnecessary blank spaces. Furthermore, the controller 30 reduces the unnecessary blank spaces on the sheet and paper usage by creating the image data with the number of original documents laid out onto a single sheet, that is within the number of pages per sheet and is maximum number that does not create unnecessary blank spaces.

FIG. 13B is a diagram illustrating images formed on the sheet when the procedure of this embodiment is not executed. In FIG. 13B, in the page before the original document 2, and the page before and after the original document 9, the blank spaces are formed. The original documents 2 and 9 are not the page-layout objects.

Meanwhile, as described above, according to this embodiment, in each page, the blank space is not formed as illustrated in FIG. 13A.

The controller 30 starts to form images after reading the original documents of which the number is the number of pages per sheet when the original document that is the page-layout object does not exist until the number of original documents that the controller 30 reads in becomes the number of pages per sheet. Additionally, the controller 30 starts to form the images when it determines that the original document is not the page-layout object, when the original document that is not the page-layout object exists before the number of original documents the controller 30 reads in becomes the number of pages per sheet. According to this embodiment, the time to start image forming after reading the original documents is shortened.

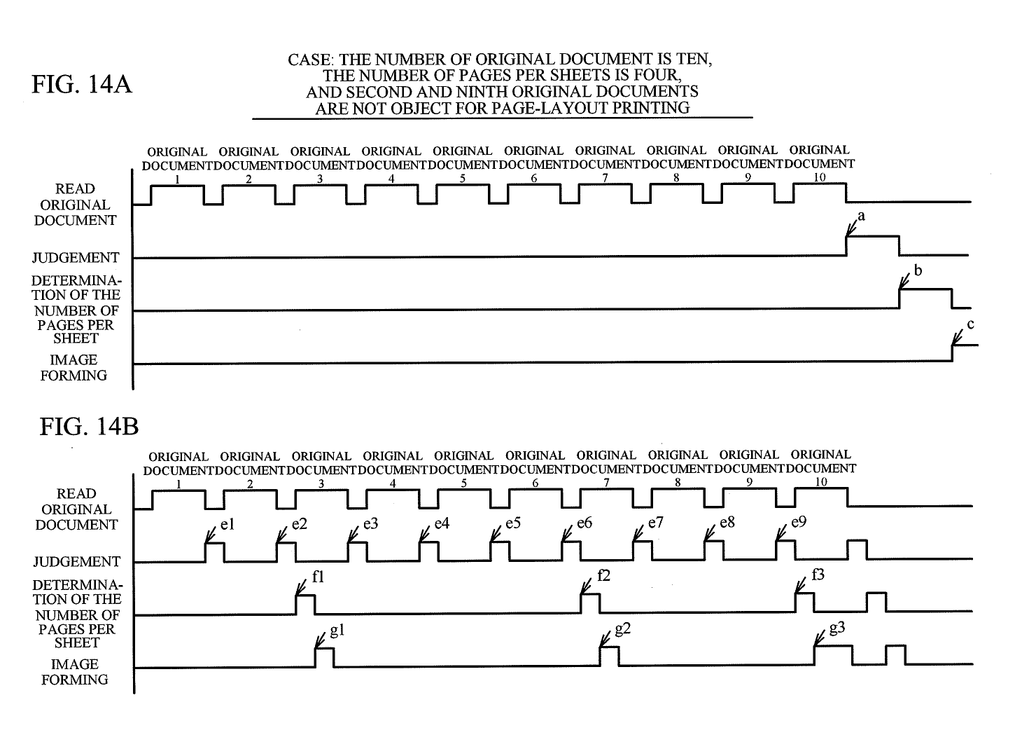

FIGS. 14A and 14B are timing charts comparing the timing of the image forming between the case that the process described in this embodiment is not executed and the case that the process described in this embodiment is executed.

FIG. 14A is a timing chart illustrating the case that the process described in this embodiment is not executed. In FIG. 14A, after the original documents 1 to 10 are read, the determination of whether each original document is the page-layout object is executed (a). The number of original documents laid out onto a single sheet is determined for each page after the determination (b). Then the image forming is started after the determination of the number of original documents laid out onto a single sheet (c).

Meanwhile, FIG. 14B is a timing chart illustrating the case that the process described in this embodiment is executed. In FIG. 14B, the determination of whether each original document is the page-layout object is executed after reading each document (e1 to e10). When the original document that is not the page-layout object exists, the number of original documents laid out onto a single sheet is determined (f1, f3), and the image forming is started (g1, g3). When the number of original documents read in becomes the number of pages per sheet, the number of original documents laid out onto a single sheet is determined (f2), and the image forming is started (g2).

Therefore, the time for the controller 30 according to this embodiment to start image forming of the first page (g1) is shortened compared to time of the case the process described in this embodiment is not executed (g1). The time to finish image forming after reading the last original document (the original document 10 in FIG. 14A) is shortened because the time to start image forming of the first page is shortened.

Although the program is stored in the ROM 303 in the embodiment described above, the device in which the program can be stored is not limited to the ROM 303. For example, a recording medium on which the software program for implementing the functions of the controller 30 is recorded may be supplied to the controller 30, and the CPU 301 may read and execute the program recorded on the recording medium. In this manner, the same effects as those of the above-described exemplary embodiment can be achieved. The recording medium for providing the program may be a CD-ROM, a DVD, or a SD card, for example.

Alternatively, the CPU 301 may execute a software program for implementing the functions of the controller 30, so as to achieve the same effects as those of the above-described exemplary embodiment.

It should be noted that the present invention is not limited to those exemplary embodiments, and various modifications may be made to them without departing from the scope of the invention.

What is claimed is:

1. A control device comprising:
a determination unit that determines a beginning original document to which a function that lays out a plurality of original documents onto a single sheet with predetermined number of original documents and forms an image is applied;
a judgment unit that sequentially judges whether the original document is a page-layout object which is laid out onto a single sheet together with other original documents, starting with the beginning original document;
an original document number determination unit that determines the number of original documents formed on a single sheet, that is within the predetermined number of original documents and does not make blank spaces, based on the number of original documents to which judgments by the judgment unit are done and judgment results of the judgment unit; and
an image forming start unit that makes an image forming unit start to form the image based on the number of original documents determined by the original document number determination unit.

2. The control device according to claim 1, wherein the original document number determination unit determines that the number of original documents formed on a single sheet is a maximum number that is within the predetermined number of original documents and does not make blank spaces.

3. The control device according to claim 1, wherein the original document number determination unit determines the number of original documents formed on a single sheet for the original documents from the beginning original document to which the function is applied to the original document that the judgment unit does not judge as the page-layout object.

4. The control device according to claim 1, wherein the original document number unit determines that the number of original documents formed on a single sheet is the predetermined number of original documents when the judgment unit judges whether the number of original documents equivalent to the predetermined number of original document are the page-layout documents and judges that the original documents that the judgment unit finishes judging are the page-layout objects.

5. The control device according to claim 1, wherein whether the original document is the page-layout object that is laid out onto a single sheet together with other original documents is judged by judging whether characters contained in the original document are legible when the original document is laid out onto a single sheet together with other original documents.

6. The control device according to claim 1, wherein whether the original document is the page-layout object that is laid out onto a single sheet together with other original documents is predetermined.

7. An image forming apparatus comprising:
a determination unit that determines a beginning original document to which a function that lays out a plurality of original documents onto a single sheet with predetermined number of original documents and forms an image is applied;
a judgment unit that sequentially judges whether the original document is a page-layout object which is laid out onto a single sheet together with other original documents, starting with the beginning original document;
an original document number determination unit that determines the number of original documents formed on a single sheet, that is within the predetermined number of original documents and does not make blank spaces, based on the number of original documents to which judgments by the judgment unit are done and judgment results of the judgment unit; and
an image forming unit that start to form the image based on the number of original documents determined by the original document number determination unit.

8. A computer readable medium causing a computer to execute a process, the process comprising:
determining a beginning original document to which a function that lays out a plurality of original documents onto a single sheet with predetermined number of original documents and forms an image is applied;
judging sequentially judges whether the original document is a page-layout object which is laid out onto a single sheet together with other original documents, starting with the beginning original document;
determining the number of original documents formed on a single sheet, that is within the predetermined number of original documents and does not make blank spaces, based on the number of original documents to which judgments by the judgment unit are done and judgment results of the judgment unit; and
making an image forming unit start to form the image based on the number of original documents determined.

9. A control method comprising:
determining a beginning original document to which a function that lays out a plurality of original documents onto a single sheet with predetermined number of original documents and forms an image is applied;
judging sequentially judges whether the original document is a page-layout object which is laid out onto a single sheet together with other original documents, starting with the beginning original document;
determining the number of original documents formed on a single sheet, that is within the predetermined number of original documents and does not make blank spaces, based on the number of original documents to which judgments by the judgment unit are done and judgment results of the judgment unit; and
making an image forming unit start to form the image based on the number of original documents determined.
